(19) United States
(12) Patent Application Publication
(10) Pub. No.: US 2023/0214719 A1
(43) Pub. Date: Jul. 6, 2023

(54) METHOD FOR PERFORMING CONTINUAL LEARNING USING REPRESENTATION LEARNING AND APPARATUS THEREOF

(71) Applicant: Research & Business Foundation Sungkyunkwan University, Suwon-si (KR)

(72) Inventors: Simon Sungil WOO, Suwon-si (KR); Minha KIM, Suwon-si (KR); Shahroz TARIQ, Suwon-si (KR)

(73) Assignee: Research & Business Foundation Sungkyunkwan University, Suwon-si (KR)

(21) Appl. No.: 18/092,590

(22) Filed: Jan. 3, 2023

(30) Foreign Application Priority Data
Dec. 31, 2021 (KR) 10-2021-0193919

(51) Int. Cl. G06N 20/00; G06N 5/022

(52) U.S. Cl. CPC G06N 20/00; G06N 5/022

(57) ABSTRACT

The present disclosure relates to a continual learning technology using machine learning, and a method for performing continual learning by a learning apparatus includes generating a teacher network and a student network from a pre-trained model using knowledge distillation, generating a representation memory configured of a plurality of storages as many as the number of classes to store feature representation values in the teacher network and the student network, extracting the feature representation value for target data through the teacher network and storing the feature representation value in the storage before learning is entered, entering the learning to extract the feature representation value for the target data through the student network and storing the feature representation value in the storage, and calculating a representation loss using values derived from the storage of the teacher network and the storage of the student network.

### CROSS-REFERENCE TO RELATED APPLICATIONS

This application claims the benefit under 35 USC §119(a) of Korean Patent Application No. 10-2021-0193919, filed on Dec. 31, 2021, in the Korean Intellectual Property Office, the entire disclosure of which is incorporated herein by reference, for all purposes.

### BACKGROUND

### Field

The present disclosure relates to a continual learning technology using machine learning, and more particularly, to a method for performing continual learning on a new task in a continual learning process using a teacher network and a student network according to a knowledge distillation scheme, and an apparatus using the same.

### Related Art

Artificial intelligence (AI) researchers have been trying to improve the performance of AI by mimicking human cognitive mechanisms. One such effort is transfer learning. Humans quickly learn new content on the basis of content that the humans have learned in the past. Transfer learning, which started from an idea of whether AI can learn similar tasks in the different domains well on the basis of content that AI has learned in the past, is a scheme for creating a model with a high learning rate and excellent performance by utilizing pre-trained weights of a well-trained model for learning of new model tasks in different domains.

While such machine learning models emphasize a final result for a learning process, the models often ignore a key feature of human learning such as robustness and adaptability towards evolving tasks and learning sequential problems. On the other hand, this robustness stands in sharp contrast to the most efficient state-of-the-art deep learning models, which generally tend to excel, when a large amount of shuffled, balanced, and homogeneous data is carefully provided. These models not only underperform when faced with slightly different data distributions, but also fail or experience sharp performance degradation on previously learned tasks. That is, a catastrophic problem that a newly trained model forgets past learning content has been found.

A current artificial neural network exhibits excellent performance for a single task, but when other types of tasks are presented and learned, the performance for previously learned tasks significantly deteriorates, and such a phenomenon is called catastrophic forgetting (knowledge forgetting). In the catastrophic forgetting, a large amount of information on a previous training dataset is lost even when there is a correlation between the previous training dataset and the new training dataset. One area where this phenomenon can be clearly observed is fake multimedia detection, especially, deepfake video and GAN-generated image detection, where different types of fake multimedia generation methods are applied.

Recently, these types of synthetic multimedia from the advanced artificial intelligence (AI) systems are becoming more widespread in social media and online forums for creating fake news and information. The recent progress made in deep learning technologies have greatly assisted in generating synthetic images and videos that look strikingly similar to real-world images and videos. Moreover, a large number of fake image generation tools, such as FaceApp, FakeApp, and ZAO, are also available, which aggravates the situation. It is not secret that deepfakes can severely harm multimedia technologies. The fake multimedia is generally present in two forms on the Internet: deepfake videos and GAN-generated synthetic images. On the other hand, there are many fake media detection methods proposed in recent years, achieving state-of-the-art performance. However, the fake media detection methods suffer from the same robustness and generalization issues when evaluated with a data distribution different from the training set.

Therefore, there is a need for a new technique capable of improving detection performance of target data to be newly learned while maintaining detection performance of a pre-trained deep learning model without forgetting knowledge in such a transfer learning or continual learning process.

### Non-Patent Document

Shruti Agarwal, Hany Farid, Tarek El-Gaaly, and Ser-Nam Lim. 2020. Detecting deep-fake videos from appearance and behavior. In 2020 IEEE International Workshop on Information Forensics and Security (WIFS). IEEE, 1-6.

### SUMMARY

The technical problem to be solved by the present disclosure is to overcome the limitation of occurrence of a knowledge forgetting phenomenon in which previously learned data cannot be detected in a transfer learning process attempted against various limitations caused by learning individual models, to overcome the weakness of requiring a large amount of source data to maintain the detection performance of deep learning networks, and to solve the problem of insufficient learning performance for tasks applied to a new domain.

In order to solve the above technical problem, a method for performing continual learning by a learning apparatus including at least one processor includes a step (a) of generating, by the learning apparatus, a teacher network and a student network from a pre-trained model using knowledge distillation; a step (b) of generating, by the learning apparatus, a representation memory configured of a plurality of storages as many as the number of classes to store feature representation values in the teacher network and the student network; a step (c) of extracting, by the learning apparatus, the feature representation value for target data through the teacher network and storing the feature representation value in the storage before learning is entered; a step (d) of entering, by the learning apparatus, the learning to extract the feature representation value for the target data through the student network and storing the feature representation value in the storage; and a step (e) of calculating, by the learning apparatus, a representation loss using values derived from the storage of the teacher network and the storage of the student network.

In the method for performing continual learning according to the embodiment, the step (a) of generating a teacher network and a student network may be performed by knowledge distillation for transferring knowledge of the teacher network serving as a large model to the student network serving as a relatively small model by referring to the pre-trained model, and the teacher network and the student network may designate models trained in a previous task as a teacher model and a student model of a current task, respectively.

In the method for performing continual learning according to the embodiment, the step (b) of generating a representation memory may include dividing the classes into ground truth classified according to tasks to be performed by the model, generating representation memories as many as the number of classes for storing the feature representation values, dividing the generated memory into a plurality of storages, and setting a limited range of storable values for each storage.

In the method for performing continual learning according to the embodiment, the step (c) of storing the feature representation value in the storage through the teacher network may include a step (c1) of receiving the target data and inputting the target data to the teacher network; a step (c2) of applying a softmax function to an output value to determine a value in a predetermined range; a step (c3) of extracting a feature map belonging to a last layer of the teacher network when the input target data is inferred as ground truth; a step (c4) of calculating an average value of a feature map pooled by applying max pooling from the extracted feature map to acquire the feature representation value; and a step (c5) of storing the acquired feature representation value in the storage corresponding to the determined value in the predetermined range, and wherein the step (c) may be performed before learning is entered.

In the method for performing continual learning according to the embodiment, the step (d) of storing the feature representation value in the storage through the student network may include a step (d1) of receiving the target data and inputting the target data to the student network; a step (d2) of applying a softmax function to an output value to determine a value in a predetermined range; a step (d3) of extracting a feature map belonging to a last layer of the student network when the input target data is inferred as ground truth; a step (d4) of acquiring a feature representation value from the extracted feature map; and a step (d5) of storing the acquired feature representation value in the storage corresponding to the determined value in the predetermined range, and the step (d) may be performed by learning is entered.

In the method for performing continual learning according to the embodiment, the step (e) of calculating the representation loss may include performing a mean square of the average values stored in the storage of the teacher network and the average values stored in the storage of the student network to calculate the representation loss.

Furthermore, hereinafter, a computer-readable recording medium having a program recorded thereon, the program causing a computer to execute the method for performing continual learning described above is provided.

In order to solve the above technical problem, a learning apparatus according to an embodiment of the present disclosure includes an input unit configured to receive at least one task and target data according to the task; a storage unit constituting a representation memory for storing a feature representation value; and a processor configured to execute a program for performing continual learning using the representation memory, wherein the program executed by the processor includes instructions for: generating a teacher network and a student network from a pre-trained model using knowledge distillation, generating a representation memory configured of a plurality of storages as many as the number of classes to store feature representation values in the teacher network and the student network, extracting the feature representation value for target data through the teacher network and storing the feature representation value in the storage before learning is entered, entering the learning to extract the feature representation value for the target data through the student network and storing the feature representation value in the storage, and calculating a representation loss using values derived from the storage of the teacher network and the storage of the student network.

In the learning apparatus according to the embodiment, the program executed by the processing unit may be performed by knowledge distillation for transferring knowledge of the teacher network serving as a large model to the student network serving as a relatively small model by referring to the pre-trained model, and the teacher network and the student network may designate models trained in a previous task as a teacher model and a student model of a current task respectively.

In the learning apparatus according to the embodiment, the program executed by the processing unit may divide the classes into ground truth classified according to tasks to be performed by the model, generate representation memories as many as the number of classes for storing the feature representation values, divide the generated memory into a plurality of storages, and set a limited range of storable values for each storage.

In the learning apparatus according to the embodiment, the program executed by the processing unit may include instructions for receiving target data, inputting the target data to the teacher network, applying a softmax function to an output value to determine a value in a predetermined range, extracting a feature map belonging to a last layer of the teacher network when the input target data is inferred as ground truth, calculating an average value of a feature map pooled by applying max pooling from the extracted feature map to acquire the feature representation value, and storing the acquired feature representation value in the storage corresponding to the determined value in the predetermined range, and the process of storing in the storage through the teacher network may be performed before the learning is entered.

In the learning apparatus according to the embodiment, the program executed by the processing unit may include instructions for receiving the target data and inputting the target data to the student network, applying a softmax function to an output value to determine a value in a predetermined range, extracting a feature map belonging to a last layer of the student network when the input target data is inferred as ground truth, and acquiring a feature representation value from the extracted feature map, and storing the acquired feature representation value in the storage corresponding to the determined value in the predetermined range, and a process of storing in the storage through the student network may be performed after entering learning.

In the learning apparatus according to the embodiment, the program executed by the processing unit may perform a mean square of average values stored in the storage of the teacher network and average values stored in the storage of the student network to calculate the representation loss.

According to the embodiments of the present disclosure, it is possible to prevent a knowledge forgetting phenomenon while maintaining the performance of an existing model as much as possible without source data through the representation memory at the time of transfer learning or continual learning using a teacher-student network structure and the representation learning of a knowledge distillation scheme, and it is possible to achieve effective performance improvement in learning various target domains.

### BRIEF DESCRIPTION OF THE DRAWINGS

FIG. 1 is a diagram illustrating a knowledge distillation scheme.

FIG. 2 is a flowchart illustrating a method of performing continual learning using representation learning according to an embodiment of the present disclosure.

FIG. 3 is a diagram illustrating a continual learning process based on a teacher-student framework using the representation learning.

FIG. 4 is a diagram illustrating an entire pipeline of an architecture that performs continual learning using the representation learning.

FIG. 5 is a diagram illustrating an objective function including a representation loss proposed by embodiments of the present disclosure.

FIG. 6 is a flowchart illustrating a process of storage in a representation memory in a teacher network before model learning is performed.

FIG. 7 is a flowchart illustrating a process of storage in a representation memory of a student network and learning during model learning.

FIG. 8 is a block diagram illustrating a learning apparatus that performs continual learning using representation learning according to an embodiment of the present disclosure.

### DESCRIPTION OF EXEMPLARY EMBODIMENTS

When tasks belonging to various domains are performed through pre-trained deep learning models, a catastrophic forgetting (knowledge forgetting) problem from domain shifting predominantly occurs in such cases. Specifically, catastrophic forgetting is a phenomenon in which deep learning models tend to entirely, partially, or abruptly forget previously learned knowledge upon learning a new task. For example, performance of a classifier trained with one deepfake dataset generally degrades when a test is performed with another deepfake dataset, which is generated from a different generation method that essentially makes the underlying test dataset distribution differs from the previously learned training dataset distribution. Therefore, catastrophic forgetting should be minimized while information is transferred or new tasks are learned, and tested. On the other hand, in order to maintain knowledge during transfer of the knowledge, approaches to mitigate data distribution shifting of models by reusing source data may be utilized. By using a feature classifier based on a nearest-neighbor scheme, a distribution shift problem can be alleviated. However, this case suffers from the limitation of memory resources since the source data is stored to transfer the knowledge.

Furthermore, to overcome the catastrophic forgetting, a few data samples may be utilized from a source domain during transfer learning. However, in practice, in the case of most pre-trained models, source domain data is not available or retaining source domain data may raise privacy concerns. Therefore, to encourage maximum applicability in real-world scenarios, only data of a target domain may be used, and knowledge distillation (KD) may be applied to effectively learn from the pre-trained model (teacher). Such knowledge distillation may be effectively utilized in continual and lifelong learning scenarios.

Embodiments of the present disclosure derived from the factors considered above propose an approach based on continual learning (CL) and knowledge distillation using the representation learning (RL), which is referred to as continual representation using distillation (CoReD) throughout this specification. In the embodiments of the present disclosure, new tasks are continuously learned using a CoReD scheme, and continual learning that is a combination of the representational learning with knowledge distillation is performed to greatly improve catastrophic forgetting. Specifically, in the embodiments of the present disclosure, a total loss is configured of a student loss, a distillation loss, and the representation loss to minimize fatal forgetting in a learned task, so that new tasks can be learned sequentially and effectively to detect various deepfakes at once.

Meanwhile, continual Learning (CL), also known as life-long learning, is based on the concept of learning continuously and adaptively. In particular, Continual Learning is a kind of general online learning framework that learn from an infinite stream of data. Especially, several CL methods have been introduced to solve the problem of catastrophic forgetting and adapt to dynamically changing tasks. Moreover, CL systems have shown a function of adapting to and performing well on the entire datasets without revisiting all previous pieces of data at each training stage. Such advantages of CL can tackle key limitations that are prevalent in deep learning and machine learning for generalization and a new task learning. For example, over time, the trained model generally suffers from covariate and knowledge shifts due to vastly and gradually increased size of new datasets, which is also known as catastrophic forgetting. A constraint-based approach called elastic weight consolidation (EWC) may be utilized to alleviate catastrophic forgetting in neural networks by selectively restraining the plasticity of weights depending on the importance of weights to previous tasks. However, such approach shows a lack of scalability because the network size scales quadratically with respect to the number of tasks. The embodiments of the present disclosure propose a method that prevents forgetting of knowledge by referring the features of target data without constraints and source data.

Representation learning (RL) is an approach of learning underlying representations of input data, through transforming or extracting features from data, in order to render machine learning tasks easier to perform. Recent research explored transferable representation learning with deep adaptation networks to improve the feature transferability in domain adaptation tasks. Such approach embeds deep features of all task-specific layers into kernel Hilbert spaces (RKHSs), matching optimum domain distributions forming a minimax game. However, this has not been designed for continual learning setup. Further, new spatiotemporal feature representation learning, which is robust to a representation intensity variation, may be considered, but such approach is not suitable in that the approach only considers two different datasets, which may not be sufficient to assess generalization performance.

A pioneering knowledge distillation (KD) was first proposed in order to compress and transfer knowledge of a large (teacher) model to a small (student) model. The essence of a knowledge distillation training process is for a student model to effectively mimic the capability of a teacher model. From the continual learning task, a forgetting framework with learning was proposed to improve catastrophic forgetting by utilizing the knowledge distillation during transfer learning. In addition, to address catastrophic forgetting in class-incremental learning, rehearsal principle and a knowledge distillation loss were proposed. Such a task stores exemplars in a source task to prevent complete forgetting of the source task. However, for complex inputs, this approach typically requires a very large memory storage to store functions of the source domain. To mitigate such a large space requirement, the proposed embodiments of the present disclosure are designed such that it not necessary to store or use source exemplars during a new task learning through CoReD based on continual and representation learning utilizing the knowledge distillation.

Utilization in multi-task lifelong learning is possible by striking a better balance between preservation and adaptation via distillation and retrospection. A relevant approach based on a convolutional neural network (CNN) not only is helpful in learning on a new task, but also preserves the performance of previous tasks. In particular, the retrospection is designed to cache a small subset of data for old tasks, which proves to be greatly helpful for the performance preservation, especially in long sequences of tasks drawn from different distributions. Embodiments of the present disclosure adopts some similar approach, and focuses on continual representation.

As many new deepfake videos (or GAN images) generation methods are introduced as illustrated above, detecting all fake images is becoming more challenging and time-consuming. Therefore, a continual learning-based solution can be beneficial, especially when a data distribution contains an overlap between different generation methods, as in the case of deepfake videos (or GAN images). Consequently, the embodiments of the present disclosure propose technical means for effectively detecting fake media from various generation methods by using continual learning in a teacher-student model setting. Through this, the embodiments of the present disclosure are intended to cause target data to which a scheme for generating other domains has been applied to be learned, while maintaining the performance of an existing model as much as possible without separate or additional prior data.

Hereinafter, the embodiments of the present disclosure will be described in detail with reference to the drawings. However, detailed descriptions of well-known functions or configurations that may obscure the gist of the present disclosure will be omitted in the following description and accompanying drawings. In addition, “include” a certain component means that another component may be further included without exclusion of the other component unless otherwise stated, throughout the specification.

Further, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure.

The terminology used herein is for the purpose of describing particular embodiments only and is not intended to be limiting of the disclosure. The singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless particularly otherwise defined, all terms including technical and scientific terms used herein have the same meaning as commonly understood by those skilled in the art to which the present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

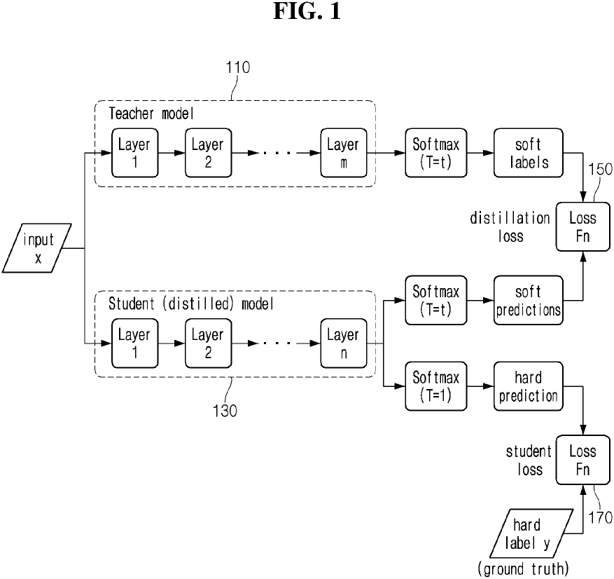

FIG. 1 is a diagram illustrating a knowledge distillation scheme.

The purpose of the knowledge distillation is to transfer knowledge of a large network (teacher network) that has been well trained in advance to a small network (student network) that desires to actually use the knowledge. Since a deep learning model is universally wide and deep, feature extraction is performed better when the number of parameters is large and an amount of calculation is large, and accordingly, the performance of classification or object detection, which is the purpose of the model, is expected to be improved. However, when a smaller model can achieve as much performance as a larger model, it is possible to achieve better efficiency in terms of computing resources (GPU or CPU), energy (battery or the like), and a memory. The knowledge distillation is designed to improve the performance of the student network by transferring knowledge of the teacher network to the student network in a learning process, so that even a small network can exhibit performance similar to a large network.

Referring to a network structure illustrated in FIG. 1, learning for an input is performed through a teacher model 110 and a student model 130, and a distillation loss 150 and a student loss 170 are calculated from labels or prediction values output from the teacher model 110 and the student model 130. Here, the student loss 170 is a loss of classification performance, and a difference between the ground truth and a student classification result may be calculated as a cross entropy loss. Further, the distillation loss 150 includes a difference between classification results of the teacher network 110 and the student network 130. A difference between values obtained by converting respective outputs of the teacher network 110 and the student network 130 using softmax may be calculated as the cross entropy loss. A total loss function can be constructed from the two losses 150 and 170.

However, the representation loss proposed by the embodiments of the present disclosure is not considered in such a loss function, as introduced above. Therefore, hereinafter, a technical means for representing and recording the representation loss is proposed.

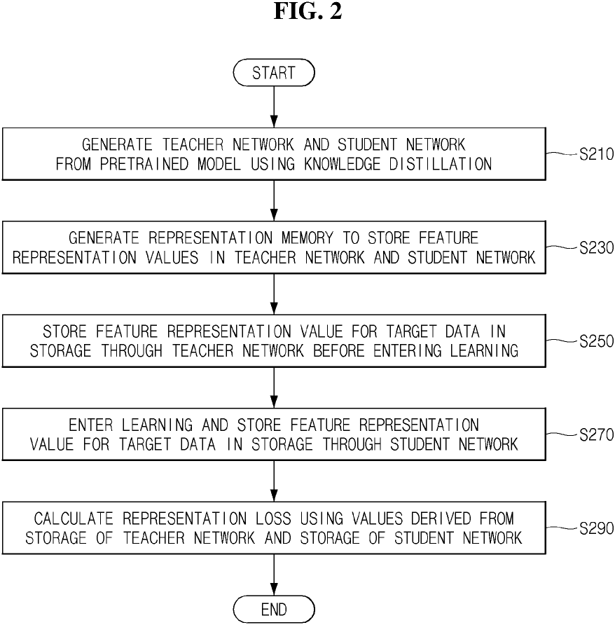

FIG. 2 is a flowchart illustrating a method of performing continual learning using the representation learning according to an embodiment of the present disclosure. Such a continual learning process may be implemented as a program including instructions for processing a series of processes that will be described hereinafter, and may be performed by a learning apparatus including at least one processor that executes such a program.

In step S210, the learning apparatus generates the teacher network and the student network from the pre-trained model using knowledge distillation. This process is performed by knowledge distillation for transferring knowledge of the teacher network serving as a large model to the student network serving as a relatively small model by referring to the pre-trained model, and the teacher network and the student network may designate models trained in a previous task as the teacher model and the student model of the current task respectively.

In step S230, the learning apparatus generates a representation memory configured of a plurality of storages as many as the number of classes to store feature representation values in the teacher network and the student network. In this process, the classes may be divided into ground truth classified according to tasks to be performed by the model, representation memories may be generated as many as the number of classes for storing the feature representation values, the generated memory may be divided into a plurality of storages, and a limited range of storable values may be set for each storage.

For example, in the case of a binary classification task for detecting fake or real videos, ‘fake’ or ‘real’ becomes ground truth. A feature representation value is acquired through the data classified into ground truth and stored in the representation memory, and in this case, when feature representation value is stored in the memory generated for each class, it is possible to elaborately learn each class in the learning process. Further, the generated memory is divided into several storages, and a range of storable values in each storage is limited. For example, the memory can be divided into five storages as unit sections of 0.1 with reference to a value of 0.5. Therefore, the respective storages can have a value in a range {[0.5, 0.6), [0.6, 0.7), [0.7, 0.8), [0.8, 0.9), and [0.9, 1.0]}.

In step S250, the learning apparatus extracts the feature representation value for the target data through the teacher network before entering learning, and stores the feature representation value in the corresponding storage. Since the teacher network and the student network are generated with a pre-trained deep learning model, and the representation memory of the teacher network is generated before learning is performed, the target data is input, and a teacher feature representation value is acquired and stored in an appropriate storage.

In step S270, the learning apparatus enters the learning, extracts the feature representation value for the target data through the student network, and stores the feature representation value in the corresponding storage. When learning is entered, the target data is input to the student network, and the feature representation value is acquired and stored in an appropriate storage, as in step S250.

In step S290, the learning apparatus calculates the representation loss using values derived from the storage of the teacher network and the storage of the student network. Now, in this process, it is possible to calculate the representation loss by performing a mean square of average values in the storage of the teacher network and average values in the storage of the student network.

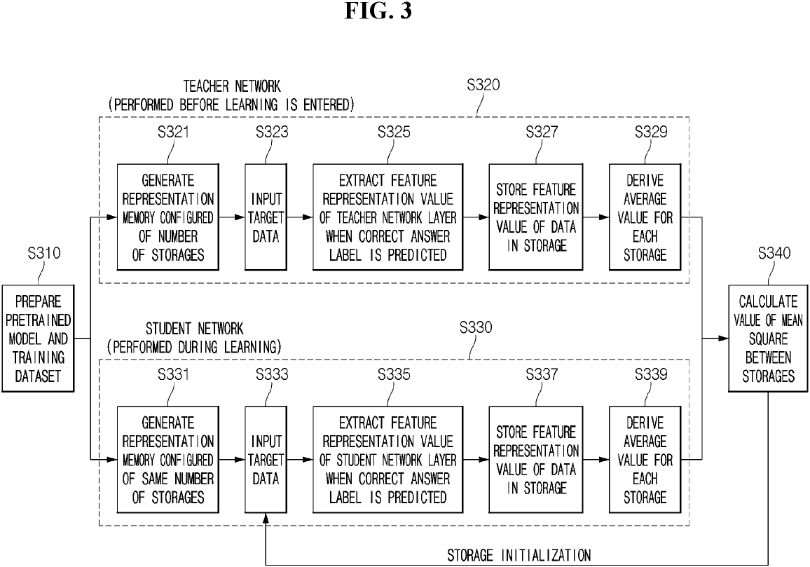

FIG. 3 is a diagram illustrating a continual learning process based on a teacher-student framework using the representation learning.

Referring to FIG. 3, it is shown that the process is divided into a step that is performed through the teacher network before learning (S320) and a step that is performed through the student network during the learning (S330). First of all, in step S310, a pre-trained model and a training dataset are prepared.

The teacher network and the student network are generated with a pre-trained deep learning model before learning is performed, and in step S321, the representation memory of the teacher network is generated. Then, in step S323, the target data is input, and a teacher feature representation value is acquired and stored in an appropriate storage. More specifically, a feature representation value of a teacher network layer is extracted when ground truth label is predicted in step S325, the feature representation value of the data is stored in the storage in step S327, and then an average value is derived for each storage in step S329.

When the learning is entered, as in the above process (S320), a representation memory configured of the same number of storages as in step S321 is generated in step S331, and the target data is input to the student network to acquire the feature representation value, and stored in the appropriate storage in step S333. More specifically, when the ground truth label is predicted, a feature representation value of a student network layer is extracted in step S335, a feature representation of the data is stored in the storage in step S337, and then an average value is derived for each storage in step S339.

Finally, in step S340, the mean square is performed between the average values in the storage of the teacher network and the average values in the storage of of the student network.

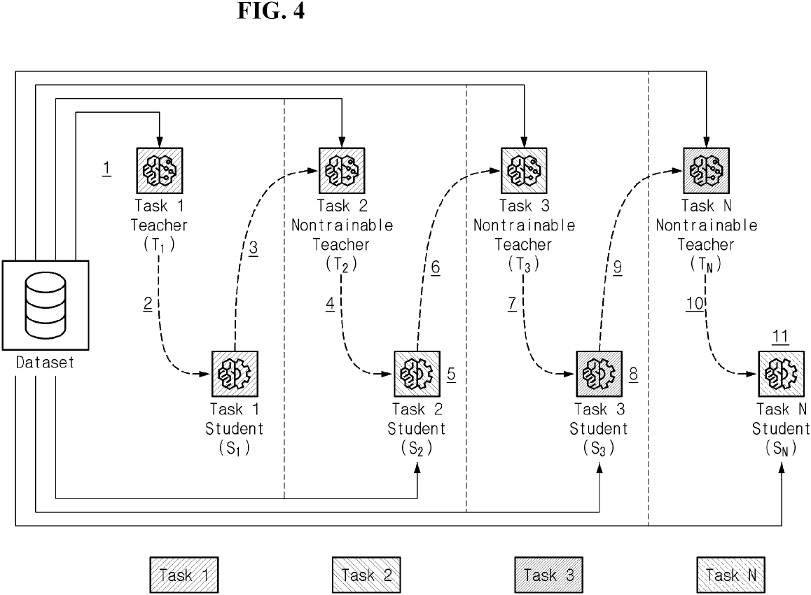

FIG. 4 is a diagram illustrating an entire pipeline of an architecture that performs continual learning using representation learning, and proposes, for example, a workflow of a CoReD method for fake multimedia detection.

Given deepfake videos (X_{d}) or GAN images (X_{g}) of all generation methods, a goal of the present embodiment is to classify the videos or images into real or fake ones. An entire pipeline of the proposed approach is shown from step 1 to step 11 in FIG. 4. However, since subsequent processes are only repetitions of these steps, only first six processes from steps 1 to 6 will be described below.

(Step 1) First, a teacher model T₁ is fully trained using a task 1 dataset.

(Step 2) a weight is copied from the teacher trained in task 1 to a student model S₁.

(Step 3) Now, the student is changed to a teacher of task 2 (T₂) and T₂ is set to untrainable.

(Step 4) Next, the weight is copied from the task 2 teacher T₂, and S₂ is set to learnable to create a new student model S₂.

(Step 5) Now, data of task 2 is provided to T₂ and S₂. A student performs learning from the data according to three methods: (a) directly using the cross entropy loss (student loss Ls), (b) using the representation loss calculated from between T₂ and S₂ by comparing feature representation memories (representation loss L_{R}), and (c) using a knowledge distillation loss (distillation loss L_{D}) calculated using T₂ and S₂. Details of each loss will be described below. For reference, since T₂ is set to untrainable, a functional representation memory and knowledge remain the same. However, in the case of S₂, the functional representation memory and knowledge gradually changes during a training period.

(Step 6) When a student S₂ is fully trained, the process returns to (Step 3), this is used as a teacher for the next task (that is, T₃), and this process is repeated until all tasks (that is, step 11 in FIG. 4) are completed.

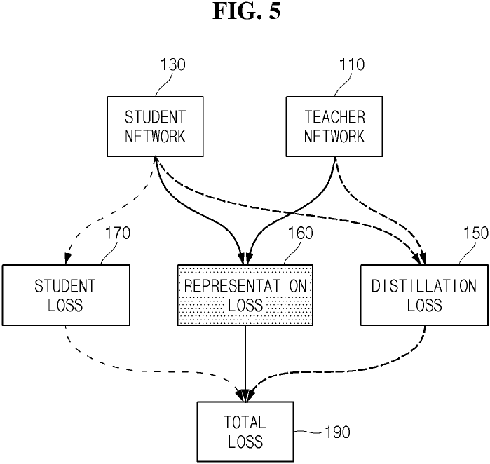

FIG. 5 is a diagram illustrating an objective function including the representation loss proposed by the embodiments of the present disclosure. Three loss functions for CoReD, that is, the student loss 170, the representation loss 160, and the distillation loss 150 can be calculated by using the labels or predicted values acquired from the teacher network 110 and the student network 130 to derive a total loss 190.

### Student Loss

As seen in steps 5, 8, and 11 of FIG. 4 above, when a student model (S) is trained, the cross entropy loss is used to directly perform learning from a dataset of a task as shown in Equation 1 below.

$$\begin{matrix}\begin{matrix}σ {\left(s\right)}_{i} = \frac{{e}^{{s}_{i}}}{{\sum }_{j}^{C} {e}^{{s}_{j}}} , \\ {L}_{S} = - {\sum }_{i = 1}^{C = 2} {t}_{i} log \left(σ {\left(S \left({x}_{i} , {y}_{i}\right)\right)}_{i}\right) \\ \begin{matrix}= - {t}_{1} log \left(σ {\left(S \left({x}_{i} , {y}_{i}\right)\right)}_{1}\right) - \left(1 - {t}_{1}\right) \\ log \left(1 - σ {\left(S \left({x}_{i} , {y}_{i}\right)\right)}_{1}\right) ,\end{matrix}\end{matrix} \\ \end{matrix}$$

where σ is the softmax function, and C₁ and C₂ are a real class and a fake class. t₁[0,1] and σ(·)₁ are ground truth and a score of C₁, and t₂ = 1 - t₁ and σ(·)₂ = 1 - σ(·)₁ are ground truth and a score for C₂. Further, yᵢ is an output label (that is, a hard label y), and ŷᵢ is an output of S (that is, hard prediction).

### Distillation Loss

When the student model is being trained in steps 5, 8, and 11 of FIG. 4, the distillation loss is also calculated using a student of the teacher model as shown in Equation 2 below.

$$\begin{matrix}\begin{matrix}{σ}_{d} {\left(s , T\right)}_{i} = \frac{{e}^{\left(\frac{{s}_{i}}{T}\right)}}{\sum {}_{j}^{C} {e}^{\left(\left(\frac{{s}_{j}}{T}\right)\right)}} , \\ {L}_{D} = {\sum }_{{x}_{i} ∈ X} L \left(T \left({x}_{i}\right) , S \left({x}_{i}\right)\right) \\ = {\sum }_{{x}_{i} ∈ X} {σ}_{d} \left(T \left({x}_{i} , {y}_{i}\right) ; T = τ\right) log {σ}_{d} \left(S \left({x}_{i ,} {\hat{y}}_{i}\right) ; T = \left(τ\right)\right) ,\end{matrix} \\ \end{matrix}$$

where σ_{d} is a softmax function with a temperature T initialized to τ during distillation. yᵢ is an output label of T (that is, a soft label y), and ŷᵢ is an output of S (that is, soft prediction). The temperature is helpful for S to mimic T when a probability distribution for the class is smoothed. Increasing T smooths a probability distribution of the softmax function, and a class T more similar to a predicted class is revealed.

### Representation Loss

In the embodiments of the present disclosure, it has been thought that there should be similar or common basic characteristics among various fake multimedia (deepfake videos or GAN images) generated in various generation ways. Thus, a teacher T trained on a task i can help a student S in learning a task i+1 using a smaller number of samples. Therefore, when the student model is being trained, feature representations of T and S for training data are stored in the representation memory (Rmem.). In the embodiments of the present disclosure, only unique characteristics are selectively stored to minimize a memory space, instead of entire i+1 data characteristics being stored, unlike previous schemes in which a large number of samples are stored.

To achieve this, the embodiments of the present disclosure apply softmax to outputs of T and S that are used to create representation memories

$${R}_{m e m .}^{T}$$

and

$${R}_{m e m .}^{S} .$$

The representation memory is divided into b small blocks (indicating storages) in units of size v, starting at a value m, and is expressed as: Rₘₑₘ. = {(m, m+v), (m+v, m+2v), ..., (m+(b-1)v, m+bv)}. The division of the memory is helpful in reducing context switching in the learning process. Because distributions of real data and fake data are different from each other, this task is performed separately on both the real data and the fake data. Finally, a difference between

$${R}_{m e m .}^{T}$$

and

$${R}_{m e m .}^{S}$$

is calculated as shown in Equation 3 below.

$${L}_{R} = {\sum }_{1}^{b} {\left‖{R}_{m e m . \left(b\right)}^{S} - {R}_{m e m . \left(\left(b\right)\right)}^{S}\right‖}_{2} {}^{2}$$

Here, in the case of binary classification, a feature storage is divided by b = 5. Each size b = 0.1 starts at m = 0.5. For example,

$${R}_{m e m . \left(1\right)}^{S}$$

represents a first block of the representation memory of the student.

### Total Loss

All of the three losses of Equations 1 to 3 are summed to construct a total loss function of CoReD as follows.

$${L}_{C o Re D} = α {L}_{S} + β {L}_{D} + γ {L}_{R}$$

where α, β, and γ are coefficients for controlling the three loss terms.

Hereinafter, a storage process for representation memory for each of the teacher network and the student network will be described in more detail.

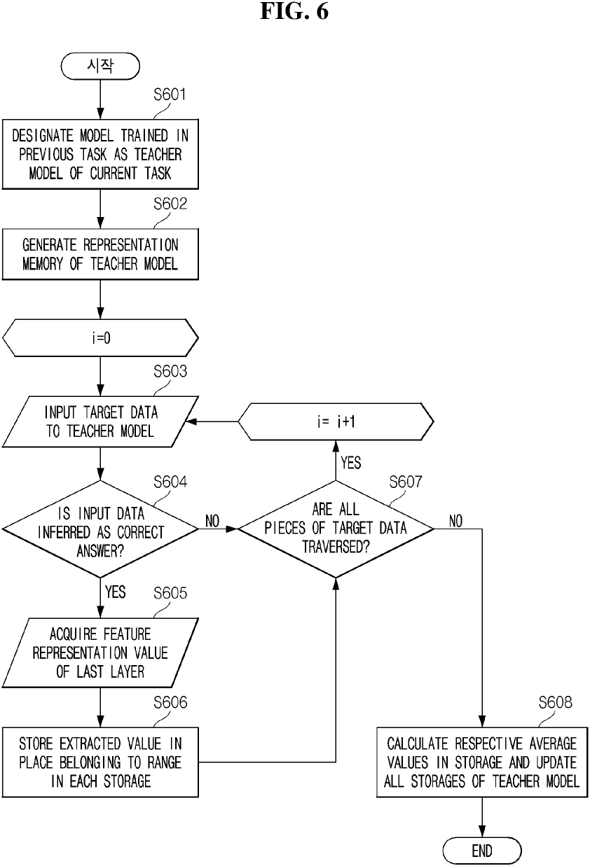

FIG. 6 is a flowchart illustrating a process of storage in the representation memory in the teacher network before model learning is performed (before learning is entered).

In step S601, a model trained in a previous task is designated as a teacher (T) model of a current task, and in step S602, a representation memory of the teacher model is generated. In this case, b storages may be generated in units of size v starting from the value m. That is, the storages of the representation memory such as Rₘₑₘ. = {(m, m+v), (m+v, m+2v), ..., (m+(b-1)v, m+bv)} may be generated.

Now, the number of pieces of target data to be traversed is initialized (i = 0), and the target data is received, and is input to the teacher network in step S603. Further, a softmax function is applied to an output value to determine a value in a preset range. For example, the value may be between 0 and 1.

In step S604, when the input target data is inferred as ground truth, the process proceeds to step S605 to extract a feature map belonging to a last layer of the teacher network. This process uses a property that a portion similar to a feature of a source domain is present in data predicted as ground truth even when the input target data is different from a domain trained by the teacher network. For example, the process utilizes the fact that, even when fake images in different ways are classified in a task, targets of the task are similar parts such as face images.

In step S606, a feature representation value is acquired by calculating an average value of a feature map pooled by applying max pooling from the extracted feature map. Then, in step S606, the extracted value is stored in a place belonging to the range in each storage. That is, the feature representation value obtained in step S606 is stored in the storage corresponding to the previously determined value in the preset range.

When all pieces of input target data are traversed in step S607, the process proceeds to step S608 to calculate average values of the feature representation values stored in the storage and update the all storages of the teacher network.

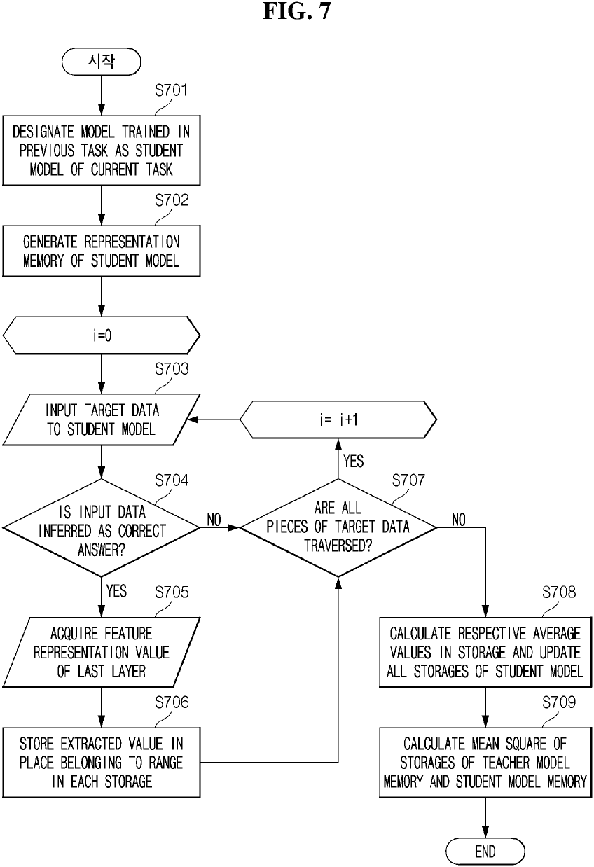

FIG. 7 is a flowchart illustrating a process of storage in the representation memory of the student network and learning during model learning.

In step S701, a model trained in a previous task is designated as a student (S) model of a current task, and in step S702, a representation memory of the student model is generated. In this case, b storages may be generated in units of size v starting from the value m. That is, the storages of the representation memory such as Rₘₑₘ. = {(m, m+v), (m+v, m+2v), ..., (m+(b-1)v, m+bv)} may be generated.

Now, the number of pieces of target data to be traversed is initialized (i = 0), and the target data is received, and is input to the student network in step S703. Further, a softmax function is applied to an output value to determine a value in a preset range. For example, the value may be between 0 and 1.

In step S704, when the input target data is inferred as ground truth, the process proceeds to step S705 to extract a feature map belonging to a last layer of the student network.

In step S706, a feature representation value is acquired by calculating an average value of a feature map pooled by applying max pooling from the extracted feature map. Then, in step S706, the extracted value is stored in a place belonging to the range in each storage. That is, the feature representation value obtained in step S706 is stored in the storage corresponding to the previously determined value in the preset range.

When all pieces of input target data are traversed in step S707, the process proceeds to step S708 to calculate average values of the feature representation values stored in the storage and update the all storages of the student network.

Finally, in step S709, the mean square of the average values stored in the storage of the teacher network and the average values stored in the storage of the student network is performed to calculate the representation loss.

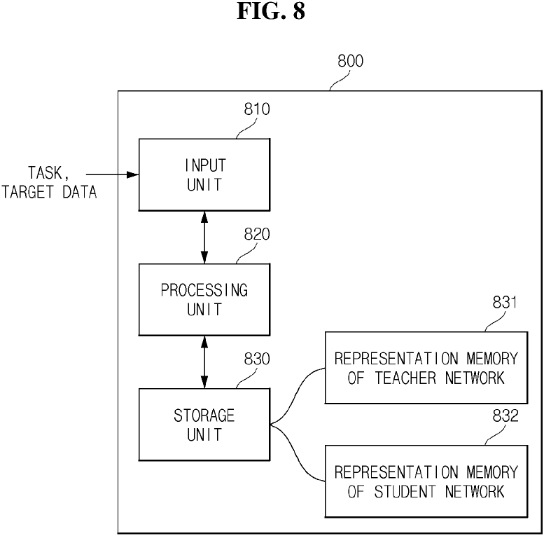

FIG. 8 is a block diagram illustrating a learning apparatus 800 that performs continual learning using the representation learning according to an embodiment of the present disclosure, which is obtained by reconstructing the method of performing continual learning in FIG. 2 from a point of view of a hardware configuration. Therefore, operations or functions to be performed by respective components will be briefly described here in order to avoid duplication of description.

An input unit 810 is a component that receives at least one task and target data according to the task.

A storage unit 830 may constitute the representation memory for storing the feature representation value, and may constitute respective separate storages 831 and 832 for the teacher network and the student network.

A processing unit 820 is a component that executes a program for performing the continual learning using the representation memory. The program executed by the processing unit 820 includes an instruction for generating the teacher network and the student network from the pre-trained model using knowledge distillation, generating a representation memory configured of a plurality of storages as many as the number of classes to store feature representation values in the teacher network and the student network, extracting the feature representation value for target data through the teacher network and storing the feature representation value in the storage before learning is entered, and entering the learning to extract the feature representation value for the target data through the student network and storing the feature representation value in the storage, and calculating the representation loss using the values derived from the storage of the teacher network and the storage of the student network.

The program executed by the processing unit 820 is performed by knowledge distillation for transferring knowledge of the teacher network serving as a large model to the student network serving as a relatively small model by referring to the pre-trained model, and the teacher network and the student network may designate the model trained in the previous task as the teacher model and the student model of the current task.

The program executed by the processing unit 820 may divide classes into ground truth classified according to tasks to be performed by the model, generate representation memories as many as the number of classes for storing the feature representation values, divide the generated memory into a plurality of storages, and set a limited range of storable values for each storage.

The program executed by the processing unit 820 includes an instruction for receiving the target data, inputting the target data to the teacher network, applying a softmax function to an output value to determine a value in a predetermined range, extracting a feature map belonging to a last layer of the teacher network when the input target data is inferred as ground truth, calculating an average value of a feature map pooled by applying max pooling from the extracted feature map to acquire the feature representation value, and storing the acquired feature representation value in the storage corresponding to the determined value in the predetermined range, wherein the process of storing in the storage through the teacher network is performed before the learning is entered. Here, the program executed by the processing unit 820 may be executed using the program executed by the processing unit is executed using a property that a portion similar to a feature of a source domain is present in data predicted as ground truth even when the input target data is different from a domain trained by the teacher network. Further, the program executed by the processing unit 820 may further include an instruction for calculating respective average values of the feature representation values stored in the storage and updating all the storages of the teacher network, when all the pieces of input target data have been traversed.

The program executed by the processing unit 820 includes instructions for receiving the target data and inputting the target data to the student network, applying a softmax function to an output value to determine a value in a predetermined range, extracting a feature map belonging to a last layer of the student network when the input target data is inferred as ground truth, acquiring a feature representation value from the extracted feature map, and storing the acquired feature representation value in the storage corresponding to the determined value in the predetermined range, and a process of storing in the storage through the student network is performed after entering learning. Further, the program executed by the processing unit 820 may further include an instruction for calculating average values of the feature representation values stored in the storage to update all the storage of the student network, when all the pieces of input target data have been traversed.

Further, the program executed by the processing unit 820 may perform the mean square of the average values stored in the storage of the teacher network and the average values stored in the storage of the student network to calculate the representation loss.

According to the above-described embodiments of the present disclosure, it is possible to prevent a knowledge forgetting phenomenon, while maintaining the performance of an existing model as much as possible without source data through the representation memory at the time of transfer learning or continual learning using a teacher-student network structure and the representation learning of a knowledge distillation scheme. Furthermore, it is possible to achieve effective performance improvement in learning various target domains.

Meanwhile, the embodiments of the present disclosure can be implemented as computer-readable codes in a computer-readable recording medium. The computer-readable recording medium includes all types of recording devices in which data that can be read by a computer system is stored.

Examples of the computer-readable recording medium include a ROM, a RAM, a CD-ROM, a magnetic tape, a floppy disk, and an optical data storage device. In addition, the computer-readable recording medium may be distributed to computer systems connected through a network so that computer-readable code can be stored and executed in a distributed manner. Functional programs, code, and code segments for implementing the present disclosure can be easily inferred by programmers in a technical field to which the present disclosure belongs.

The present disclosure has been described focusing on various embodiments thereof. Those skilled in the art pertaining to the present disclosure will be able to understand that the present disclosure can be implemented in a modified form without departing from the essential characteristics of the present disclosure. Therefore, the disclosed embodiments should be considered from an illustrative point of view rather than a limiting point of view. The scope of the present disclosure is defined in the claims rather than the foregoing description, and all differences within the equivalent scope will be construed as being included in the present disclosure.

Reference Signs List
110 Teacher network 130 Student network
150 Distillation loss 160 Representation loss
170: Student loss 190: Total loss
800: Learning apparatus
810: Input unit 820: Processing unit
830: Storage unit
831: Representation memory of teacher network
832: Representation memory of student network

What is claimed is:

1. A method for performing continual learning by a learning apparatus including at least one processor, the method comprising:
a step (a) of generating, by the learning apparatus, a teacher network and a student network from a pre-trained model using knowledge distillation;
a step (b) of generating, by the learning apparatus, a representation memory configured of a plurality of storages as many as the number of classes to store feature representation values in the teacher network and the student network;
a step (c) of extracting, by the learning apparatus, the feature representation value for target data through the teacher network and storing the feature representation value in the storage before learning is entered;
a step (d) of entering, by the learning apparatus, the learning to extract the feature representation value for the target data through the student network and storing the feature representation value in the storage; and
a step (e) of calculating, by the learning apparatus, a representation loss using values derived from the storage of the teacher network and the storage of the student network.

2. The method for performing continual learning according to claim 1,
wherein the step (a) is performed by knowledge distillation for transferring knowledge of the teacher network serving as a large model to the student network serving as a relatively small model by referring to the pre-trained model, and
the teacher network and the student network designate models trained in a previous task as a teacher model and a student model of a current task respectively.

3. The method for performing continual learning according to claim 1, wherein the step (b) includes dividing the classes into ground truth classified according to tasks to be performed by the model, generating representation memories as many as the number of classes for storing the feature representation values, dividing the generated memory into a plurality of storages, and setting a limited range of storable values for each storage.

4. The method for performing continual learning according to claim 1,
wherein the step (c) includes
a step (c1) of receiving the target data and inputting the target data to the teacher network;
a step (c2) of applying a softmax function to an output value to determine a value in a predetermined range;
a step (c3) of extracting a feature map belonging to a last layer of the teacher network when the input target data is inferred as ground truth;
a step (c4) of calculating an average value of a feature map pooled by applying max pooling from the extracted feature map to acquire the feature representation value; and
a step (c5) of storing the acquired feature representation value in the storage corresponding to the determined value in the predetermined range, and
wherein the step (c) is performed before the learning is entered.

5. The method for performing continual learning according to claim 4, wherein the step (c3) includes using a property that a portion similar to a feature of a source domain is present in data predicted as ground truth even when the input target data is different from a domain trained by the teacher network.

6. The method for performing continual learning according to claim 4, further comprising:
a step (c6) of calculating respective average values of the feature representation values stored in the storage and updating all the storages of the teacher network, when all the pieces of input target data have been traversed.

7. The method for performing continual learning according to claim 1,
wherein the step (d) includes
a step (d1) of receiving the target data and inputting the target data to the student network;
a step (d2) of applying a softmax function to an output value to determine a value in a predetermined range;
a step (d3) of extracting a feature map belonging to a last layer of the student network when the input target data is inferred as ground truth;
a step (d4) of acquiring the feature representation value from the extracted feature map; and
a step (d5) of storing the acquired feature representation value in the storage corresponding to the determined value in the predetermined range, and
the step (d) is performed after learning is entered.

8. The method for performing continual learning according to claim 4, further comprising:
a step (d6) of calculating average values of the feature representation values stored in the storage to update all the storage of the student network, when all the pieces of input target data have been traversed.

9. The method for performing continual learning according to claim 1, wherein the step (e) includes performing a mean square of average values stored in the storage of the teacher network and average values stored in the storage of the student network to calculate the representation loss.

10. One or more non-transitory computer-readable media for storing one or more instructions, wherein the one or more instructions executable by one or more processors
generate a teacher network and a student network from a pre-trained model using knowledge distillation;
generate a representation memory configured of a plurality of storages as many as the number of classes to store feature representation values in the teacher network and the student network;
extract the feature representation value for target data through the teacher network and store the feature representation value in the storage before learning is entered; and
enter the learning to extract the feature representation value for the target data through the student network and store the feature representation value in the storage; and
calculate a representation loss using values derived from the storage of the teacher network and the storage of the student network.

11. A learning apparatus comprising:
an input unit configured to receive at least one task and target data according to the task;
a storage unit constituting a representation memory for storing a feature representation value; and
a processor configured to execute a program for performing continual learning using the representation memory,
wherein the program executed by the processor includes instructions for:
generating a teacher network and a student network from a pre-trained model using knowledge distillation,
generating a representation memory configured of a plurality of storages as many as the number of classes to store feature representation values in the teacher network and the student network,
extracting the feature representation value for target data through the teacher network and storing the feature representation value in the storage before learning is entered,
entering the learning to extract the feature representation value for the target data through the student network and storing the feature representation value in the storage, and
calculating a representation loss using values derived from the storage of the teacher network and the storage of the student network.

12. The learning apparatus according to claim 11,
wherein the program executed by the processing unit is performed by knowledge distillation for transferring knowledge of the teacher network serving as a large model to the student network serving as a relatively small model by referring to the pre-trained model, and
the teacher network and the student network designate models trained in a previous task as a teacher model and a student model of a current task respectively.

13. The learning apparatus according to claim 11, wherein the program executed by the processing unit divides the classes into ground truth classified according to tasks to be performed by the model, generates representation memories as many as the number of classes for storing the feature representation values, divides the generated memory into a plurality of storages, and sets a limited range of storable values for each storage.

14. The learning apparatus according to claim 11,
wherein the program executed by the processing unit includes instructions for receiving target data, inputting the target data to the teacher network, applying a softmax function to an output value to determine a value in a predetermined range, extracting a feature map belonging to a last layer of the teacher network when the input target data is inferred as ground truth, calculating an average value of a feature map pooled by applying max pooling from the extracted feature map to acquire the feature representation value, and storing the acquired feature representation value in the storage corresponding to the determined value in the predetermined range, and
the process of storing in the storage through the teacher network is performed before the learning is entered.

15. The learning apparatus according to claim 14, wherein the program executed by the processing unit is executed using a property that a portion similar to a feature of a source domain is present in data predicted as ground truth even when the input target data is different from a domain trained by the teacher network.

16. The learning apparatus according to claim 14, wherein the program executed by the processing unit further includes an instruction for calculating respective average values of the feature representation values stored in the storage and updating all the storages of the teacher network, when all the pieces of input target data have been traversed.

17. The learning apparatus according to claim 11,
wherein the program executed by the processing unit includes instructions for
receiving the target data and inputting the target data to the student network,
applying a softmax function to an output value to determine a value in a predetermined range,
extracting a feature map belonging to a last layer of the student network when the input target data is inferred as ground truth, and
acquiring a feature representation value from the extracted feature map, and storing the acquired feature representation value in the storage corresponding to the determined value in the predetermined range, and
a process of storing in the storage through the student network is performed after entering learning.

18. The learning apparatus according to claim 14, wherein the program executed by the processing unit further includes an instruction for calculating average values of the feature representation values stored in the storage to update all the storage of the student network, when all the pieces of input target data have been traversed.

19. The learning apparatus according to claim 11, wherein the program executed by the processing unit performs a mean square of average values stored in the storage of the teacher network and average values stored in the storage of the student network to calculate the representation loss.
